(19) United States
(12) Patent Application Publication
(10) Pub. No.: US 2009/0066844 A1
(43) Pub. Date: Mar. 12, 2009

(54) PREDICTIVE TV ADJUSTMENT OF PARAMETER SUCH AS WHITE BALANCE

(75) Inventors: Javier Ayala, Tijuana (MX); Oscar Martinez, Tijuana (MX)

Correspondence Address: ROGITZ & ASSOCIATES, 750 B STREET, SUITE 3120, SAN DIEGO, CA, 92101, US

(73) Assignee: Sony Corporation and Sony Electronics Inc.

(21) Appl. No.: 11/947,507

(22) Filed: Nov. 29, 2007

Related U.S. Application Data
(60) Provisional application No. 60/993,411, filed on Sep. 11, 2007.

(51) Int. Cl. H04N 9/73

(52) U.S. Cl. 348/655; 348/E09.051

(57) ABSTRACT

Two measurements spaced a shorter time apart than a stabilization period are made of a TV display and used to access a predicted white balance adjustment database to return white balance offsets for entry into the TV.

Priority is claimed from U.S. provisional application 60/993,411 filed Sep. 11, 2007.

### I. FIELD OF THE INVENTION

The present invention relates generally to predicatively making adjustments to TV parameters such as white balance.

### II. BACKGROUND OF THE INVENTION

Many modern video displays require adjustments during assembly. Many of these adjustments in essence amount to inputting offsets into registers of the TV that are later used during operation to render demanded images, with the offsets resulting in improved picture display. Among the adjustments that are made during TV assembly are offsets for uniformity, white balance, and other parameters colloquially referred to as “SCON” and “SBRT”.

As further understood herein, in the case of some of the above parameters, e.g., white balance, a TV display typically must be energized for a period that is sufficiently long to allow the display to stabilize. Appropriate measurements are then taken and white balance offsets determined accordingly for entry into the TV.

The present invention critically recognizes that stabilization may consume relatively lengthy times periods, for instance, on the order of fifteen minutes. As understood herein, the stabilization time period consumes an inordinate amount of production line time, which in some cases can approach 40% of the total production line. For this reason, the present invention recognizes the desirability of truncating stabilization time to increase production throughput.

### SUMMARY OF THE INVENTION

A method includes obtaining a first measurement of a TV display at a first time and obtaining a second measurement of the TV display at a second time. The first and second times are temporally spaced by a period shorter than a parameter stabilization period of the TV. The method also includes using information from the measurements to access a predicted parameter adjustment database and returning parameter adjustment information from the database based on the information from the measurements.

The parameter adjustment information can be, e.g., white balance adjustment information such as white balance offset. The parameter adjustment information may be entered into the TV. The measurements can include, e.g., luminance and color when the parameter is white balance.

In non-limiting implementations the database includes plural tables, with each table including at least three columns of adjustment information respectively for low, medium, and high parameter change rates. Each table can be associated with a respective brightness level. Also, each table can be associated with a respective color temperature. Each table may be further associated with a respective TV display x, y coordinate.

In another aspect, a processor accesses a data structure to obtain TV adjustment information. The data structure includes plural tables. Each table includes three columns of adjustment information respectively for low, medium, and high parameter change rates.

In still another aspect, first and second luminance measurements of a TV display are obtained prior to display stabilization and used to obtain white balance offset information.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a non-limiting TV assembly line;

FIG. 2 is a flow chart of the overall logic of the invention;

FIG. 3 is a flow chart of non-limiting logic for obtaining generating lookup tables;

FIG. 4 is a flow chart of non-limiting logic for using the lookup tables;

FIG. 5 is a schematic diagram of a portion of non-limiting lookup table.

### DETAILED DESCRIPTION OF THE PREFERRED EMBODIMENT

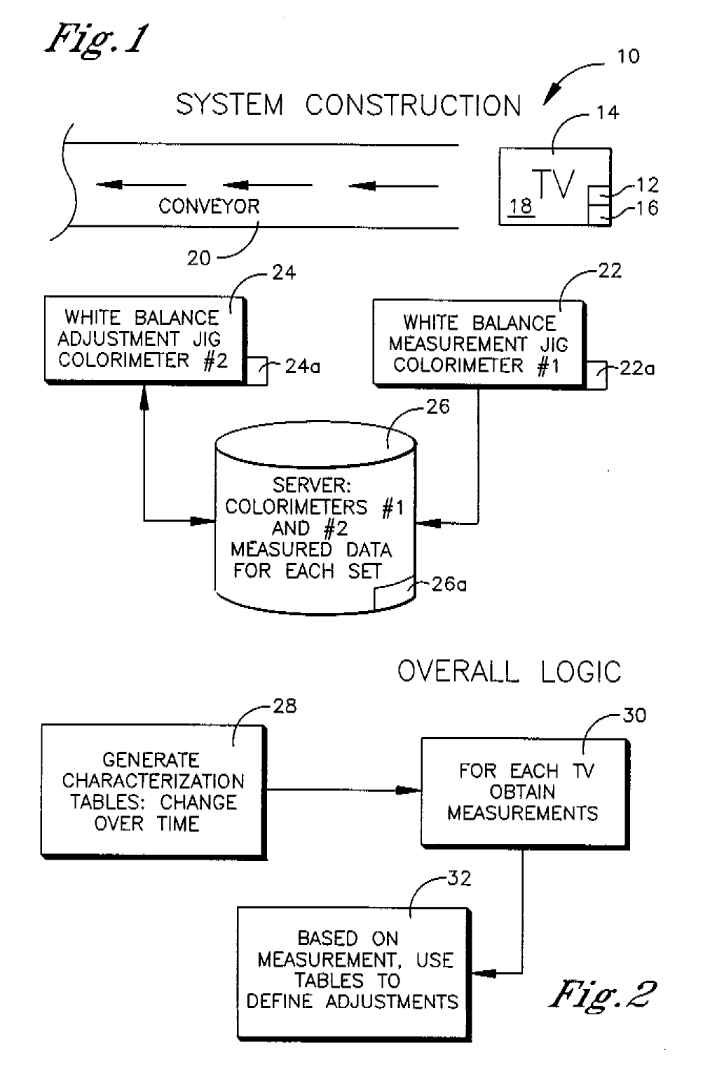

Referring initially to FIG. 1, a system is shown, generally designated 10, for entering parameter adjustment information such as white balance offsets into a register 12 of a TV 14 having a TV processor 16 and a display 18. The display 18 may be any appropriate video monitor such as a flat panel standard definition or high definition TV monitor.

As shown in FIG. 1, the TV can be conveyed by a conveyor 20 past first and second measurement stations 22, 24, referred to colloquially as “jigs”. The stations 22, 24 each include an instrument for measuring one or more attributes of TV screens as they pass by. The measured attributes are sent to a database 26, which may be a server and which is referred to in the flow charts as a “CSi” server. The stations 22, 24 and database 26 may include respective processors 22a, 24a, 26a.

The second station 24 may further include appropriate instrumentation for effecting adjustments of the parameter of interest in the TV. When white balance is the parameter of interest, the stations 22, 24 are white balance jigs, and both consequently may have colorimeters for measuring screen color and photometers for measuring luminance. In the white balance cases the second station may include white balance offset entry instrumentation in accordance with principles known in the art to effect adjustment of a TV's white balance by entering white balance offsets into the registers 12 of a TV.

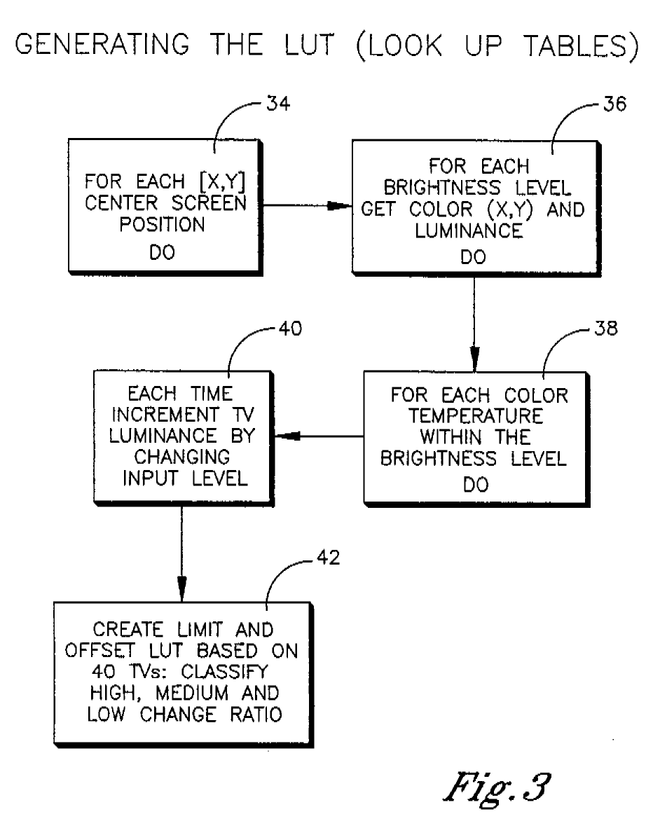

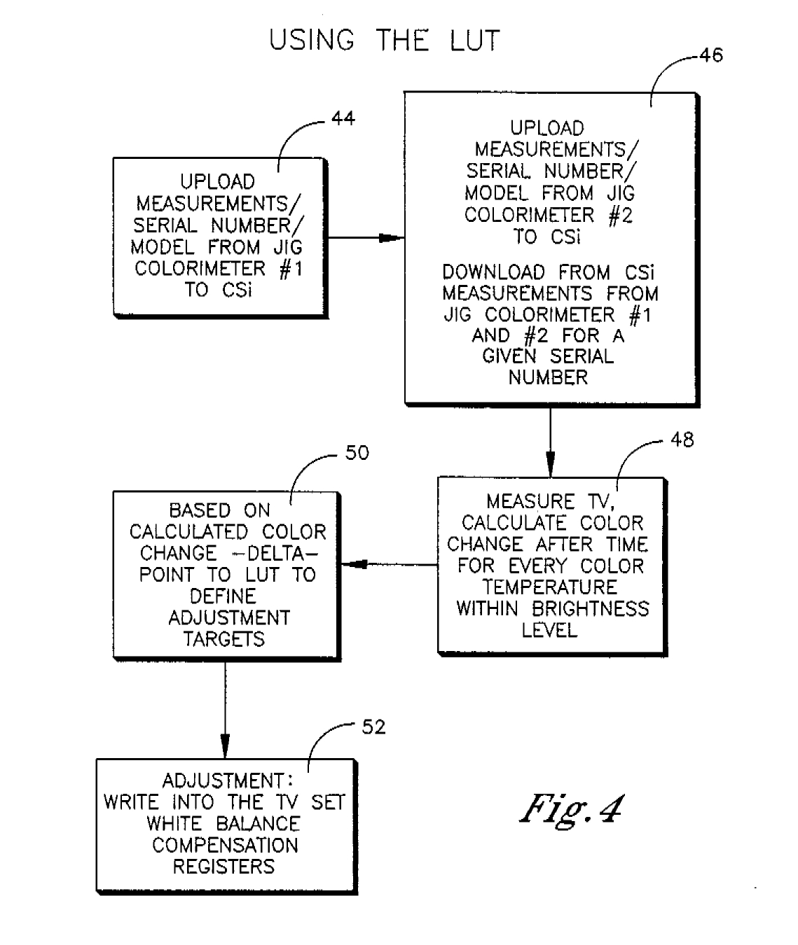

Now referring to FIG. 2, the overall logic may be appreciated. Historical change data structures (such as data tables) for one or more measurements related to the parameter of interest are generated at block 28. Details of a preferred non-limiting example of the process of block 28 are shown in FIG. 3. Subsequently, at block 30 measurements are obtained for a TV to be adjusted and then compared at block 32 to information in the historical information to obtain adjustment information such as, e.g., white balance offset information to be entered into the registers 12 of a TV 14.

FIG. 3 shows how historical white balance measurement change tables can be generated. The logic of FIG. 3 is executed for a testbed of TVs of the same models e.g., for forty TVs of the same model, with the results being averaged over the testbed.

Block 34 indicates that if desired, a table can be created for just the center x,y coordinate of the testbed TV under test or for a group of centrally located x,y coordinates. If desired, a separate table may be created for each x,y coordinate of the TV screen.

The x,y coordinates can be CIE color space coordinates; in this case, coordinates for a given color may be given in (x,y,L) where “L” is luminance. When used in capitals (i.e., X,Y) the coordinates refer to the colorimeter position relative to the screen when measurement is taken. It is preferred that the center of the screen be measured since this is typically where a viewer's focus will be.

Proceeding to block 36, for each of plural predetermined brightness levels, which can be set by appropriately establishing the input voltage, color for each of the x,y coordinates chosen and actual luminance are measured.

Blocks 38 and 40 together indicate that for each of plural preselected color temperatures within the brightness level, the luminance of the TV is incremented in predetermined steps by changing the input voltage and measurements of color and luminance are made. The logic is repeated at preferably small intervals, e.g., every two minutes, so that for each TV, color and luminance measurements are taken at each time step for each of plural brightness input levels, for each preselected color temperature within the brightness input level. The results of each testbed TV for each x,y coordinate/brightness input level/color temperature/time step combination are averaged and the differences in measurement values between time steps used to produce, at block 42, a table such as that shown in FIG. 5. Thus, each table represents the average measurements of color and luminance over the testbed TVs, for one x,y screen position selected and for one brightness input level/color temperature combination. The tables may be stored in the database 26; in a preferred non-limiting implementation, the tables are stored in the second station 24 for accessing by the associated processor 24a.

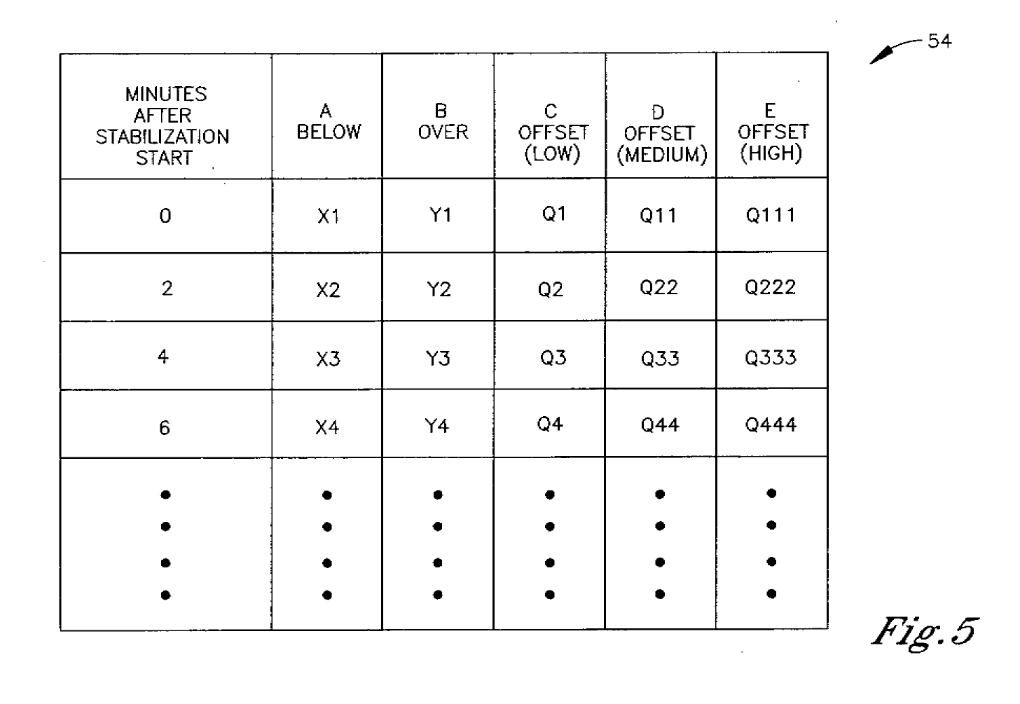

FIG. 4 shows how the historical data is used to obtain adjustment information prior to screen stabilization. The desired measurements (with times) of the TV display are obtained at block 44 from the first station 22 and uploaded if desired to the server or database 26. The model and serial number of the TV may also be uploaded. When plural x,y screen positions are measured, the positions along with their measurements and times are uploaded.

At block 46 the second measurements are made by the second station 24. The measurements from the first station 22 are downloaded from the database 26 to the second station 24, which executes the below-discussed difference calculation and table lookup. Alternatively, the measurements from the second station 24 may be uploaded to the database/server and table lookup executed by the database processor 26a. Thus, the tables may be entered and adjustments obtained by the database 26 itself with only the adjustments being downloaded to an adjustment station, such as the second station 24 when it integrates measurement and adjustment instrumentation, or the measurements may be downloaded from the database to the second station 24 and the processor 24a in the second station 24 can look up the adjustments from the tables.

In any case, block 48 indicates that the change in color measurements taken by the first and second station is calculated along with the corresponding time difference between measurements, and this is done for every color temperature measured within every brightness level that may have been measured. Only one brightness level might be used per TV. In any case, at block 50 the color temperature table corresponding to the measured brightness level (and, when used, x,y screen position) is selected and at block 52 that table is accessed using the color change calculated at block 48 (with associated time of measurement in, e.g., minutes after TV energization) as entering argument to obtain the predictive adjustment, e.g., white balance offset, for entry into the appropriate TV registers.

FIG. 5 shows an example correlation table 54, the first column of which may be a time increment column, in, e.g., minutes after stabilization started (i.e., after the TV screen was energized). For convenience, the next two columns, labeled “A” and “B”, may be limit columns, with the first column “A” containing a low change and the second column “B” containing a high change. When the actual change is below the low change of column “A”, an adjustment (such as a white balance offset) is selected from column “C” of the table. When the actual change is between the low change of column “A” and high change of column “B”, an adjustment is selected from column “D” of the table. When the actual change is above the high change of column “B”, an adjustment is selected from column “E” of the table.

While the particular PREDICTIVE TV ADJUSTMENT OF PARAMETER SUCH AS WHITE BALANCE is herein shown and described in detail, it is to be understood that the subject matter which is encompassed by the present invention is limited only by the claims. For example, while white balance adjustment is described, present principles, namely, obtaining historical parameter change data during stabilization and then using the historical data to obtain predictive adjustment values applies to other adjustments such as uniformity, SCON, SBRT, 3D gamma, and contrast, which may be measured in accordance with principles known in the art but prior to screen stabilization to obtain predictive adjustment values.

What is claimed is:

1. A method comprising:
obtaining a first measurement of a TV display at a first time;
obtaining a second measurement of the TV display at a second time, the first and second times being temporally spaced by a period shorter than a parameter stabilization period of the TV;
using information from the measurements to access a predicted parameter adjustment database; and
returning parameter adjustment information from the database based on the information from the measurements.

2. The method of claim 1, wherein the parameter adjustment information is white balance adjustment information.

3. The method of claim 2, wherein the white balance adjustment information is at least one white balance offset.

4. The method of claim 1, comprising entering the parameter adjustment information into the TV.

5. The method of claim 1, wherein the measurements include luminance.

6. The method of claim 5, wherein the measurements include color.

7. The method of claim 1, wherein the database includes plural tables, each table including at least three columns of adjustment information respectively for low, medium, and high parameter change rates.

8. The method of claim 7, wherein each table is associated with a respective brightness level.

9. The method of claim 8, wherein each table is further associated with a respective color temperature.

10. A processor accessing a data structure to obtain TV adjustment information, the data structure comprising plural tables, each table including at least three columns of adjustment information respectively for low, medium, and high parameter change rates.

11. The processor of claim 10, wherein each table is associated with a respective brightness level.

12. The processor of claim 11, wherein each table is further associated with a respective color temperature.

13. A method comprising:
obtaining first and second luminance measurements of a TV display prior to display stabilization; and
using information from the measurements to obtain white balance offset information.

14. The method of claim 13, comprising entering the white balance information into the TV.

15. The method of claim 14, wherein the information from the measurements is used to access a predicted parameter adjustment database, the white balance offset information being obtained from the database.

16. The method of claim 15, wherein the measurements include luminance.

17. The method of claim 16, wherein the measurements include color.

18. The method of claim 17, wherein the first and second measurements are taken by respective first and second stations, the second station including plural tables, each table including at least three columns of adjustment information respectively for low, medium, and high parameter change rates.
